(19) United States
(12) Patent Application Publication
(10) Pub. No.: US 2026/0167457 A1
(43) Pub. Date: Jun. 18, 2026

(54) PIT BUFFER STAND, ELEVATOR SYSTEM AND METHOD OF USING THE PIT BUFFER STAND FOR MAINTAINING AN ELEVATOR SYSTEM

(71) Applicant: Otis Elevator Company, Farmington, CT (US)

(72) Inventors: Salvador Garcia, Leganés (ES); Marcos Marra, Leganés (ES)

(21) Appl. No.: 19/389,982

(22) Filed: Nov. 14, 2025

(30) Foreign Application Priority Data
Nov. 26, 2024 (EP) 24383278.9

(51) Int. Cl. B66B 5/28

(52) U.S. Cl. CPC B66B 5/288

(57) ABSTRACT

A pit buffer stand (5) for an elevator system (1). The pit buffer stand (5) includes a first portion (510) for being fixed to a floor of a hoistway (2), a second portion (520) that forms a support for a counterweight (4) of the elevator system (1) in a maintenance mode of the elevator system (1), and a telescopic bar (530) configured for connecting the first portion (510) and the second portion (520) with each other.

### FOREIGN PRIORITY

This application claims priority to European Patent Application No. 24383278.9, filed Nov. 26, 2024, and all the benefits accruing therefrom under 35 U.S.C. § 119, the contents of which in its entirety are herein incorporated by reference.

### TECHNICAL FIELD OF INVENTION

The present disclosure relates to a pit buffer stand for an elevator system, an elevator system comprising a pit buffer stand and a method of using the pit buffer stand for maintaining an elevator system.

### BACKGROUND OF THE INVENTION

It is generally known to use a pit buffer stand to support a counterweight of an elevator system when the maintenance of the elevator system is performed to increase the area available for maintenance above an elevator car of the elevator system. It has been shown that these pit buffer stands can be relatively complex to construct and/or expensive. In addition, these pit buffer stands occupy quite a big space, and weight fillers in the lower end of the counterweight have to be designed to have a reduced width. This increases the manufacturing complexity and cost of the counterweight. Sometimes, if the weight fillers of the counterweight are not aligned properly, risks of collision or even accidents may be increased.

In this respect, it is an object of the present disclosure to provide an improved pit buffer stand where the known disadvantages of the prior art are avoided.

This object is solved by a pit buffer stand, an elevator system and a method of using the pit buffer stand for maintaining the elevator system according to the independent claims. Alternative embodiments are subject matter of the dependent claims.

### SUMMARY OF THE INVENTION

According to an aspect, a pit buffer stand for an elevator system is provided. The pit buffer stand comprises a first portion for being fixed to a floor of a hoistway, a second portion that forms a support for a counterweight of the elevator system in a maintenance mode of the elevator system, and a telescopic bar. The telescopic bar connects the first portion and the second portion with each other. This enables the length of the pit buffer stand to be adjusted. Before the maintenance of the elevator system is performed, the pit buffer stand can be extended to its maximum length. This enables a maintenance area above an elevator car of the elevator system to be set as large as possible. Thus, it is convenient for the maintenance staff to perform the maintenance. When no maintenance of the elevator system is performed, the pit buffer stand can be put in its retracted position so that the length of the pit buffer stand becomes shorter. In this situation, the pit buffer stand will occupy a relatively small space. The weight fillers in the lower end of the counterweight do not need to have a reduced width because of the shortened pit buffer stand that does not block movement of the counterweight.

According to an aspect, the telescopic bar may comprise a first part being connected to the first portion and a second part being connected to the second portion, wherein the first part and the second part are at least partially inserted into each other. This makes the telescopic bar and thus the pit buffer stand easy to be manufactured.

According to an aspect, the first part of the telescopic bar (or a portion of it) may be hollow, and the second part is inserted into the first part. This enables the pit buffer stand to be operated easily.

According to an aspect, the pit buffer stand may further comprise a traction device. The traction device may be configured to move the telescopic bar between an extended state and a retracted state. For example, the traction device may be a rope configured for being arranged between a maintenance area of the elevator system and the telescopic bar. This enables the pit buffer stand to have a simple structure and be easily operated.

According to an aspect, the pit buffer stand may further comprise a blocking device. The blocking device is movable between a blocking position, in which the first portion and the second portion of the pit buffer stand are fixed in position/are provided in a blocking position relative to each other/of the pit buffer stand, and an unblocking position, in which the first portion and the second portion are movable relative to each other/are provided in an unblocking position relative to each other/of the pit buffer stand. This allows for the pit buffer stand to be easily operated to change between its extended state and its retracted state.

According to an aspect, a first opening may be provided in the first part, at least one second opening may be provided in the second part, and the blocking device may comprise a blocking rod. The blocking rod is provided to go through/to be inserted into both the first opening and the at least one second opening to block the first part relative to the second part. Thus, the telescopic bar is kept in its retracted state. For example, the first opening and the at least one second opening are aligned with each other in the retracted state and the blocking rod penetrates through the first opening and the at least one second opening. This allows for a simple and easy manufacturing of the blocking device, and thus allows for the pit buffer stand to be manufactured simply and easily.

According to an aspect, in the extended state of the pit buffer stand, the blocking rod may penetrate through the first opening and also penetrate through another second opening, when the second portion is quite long, or the blocking rod may support a bottom end of the second part when the second portion is not very long. This enables the pit buffer stand to be kept in its extended state reliably.

According to an aspect, the traction device may be coupled with the blocking device to move it between its blocking position and its unblocking position. This enables the pit buffer stand to be kept in its extended state more reliably.

According to an aspect, the telescopic bar may include an elastic member, like a spring, being arranged along a central axis of the telescopic bar. The elastic member is compressed in the retracted state of the telescopic bar and is partially compressed or uncompressed in the extended state of the telescopic bar. This allows for the pit buffer stand to be operated between its extended state and its retracted state more easily.

According to an aspect, the first part and the second part each may have cylindrical cross sections. This allows for the pit buffer stand to be manufactured and to be operated more easily.

According to an aspect, an elevator system comprising a counterweight and a pit buffer stand according to any of the previous embodiments is provided.

According to an aspect, all weight fillers of the counterweight of the elevator system may have a uniform width from a top to a bottom of the counterweight. This avoids collisions created by an incorrect assembling of the weight fillers of the counterweight, when the weight fillers in the lower end of the counterweight have a reduced width.

According to an aspect, a method of using a pit buffer stand as described above for maintaining an elevator system is provided. The method comprises the steps: operating the pit buffer stand to change from its retracted state to its extended state (before a counterweight of the elevator system runs till the position of the pit buffer stand), and b) bringing the counterweight to be supported by the pit buffer stand for performing maintenance operation. This method enables the elevator system to be operated more safely and easily.

### BRIEF DESCRIPTION OF THE DRAWINGS

Embodiments of the present disclosure, as an example only, will be described in the following with reference to the drawings. In the drawings:

FIG. 1 schematically illustrates a side view of an elevator system;

FIG. 2 schematically illustrates a perspective side view of a pit buffer stand of the elevator system in an extended state according to one embodiment;

FIG. 3 schematically illustrates a perspective side view of the pit buffer stand in a retracted state according to the embodiment shown in FIG. 2;

FIG. 4 schematically illustrates a side view of an elevator system comprising a pit buffer stand with a traction device according to yet another embodiment;

FIG. 5 schematically illustrates a perspective side view of a pit buffer stand with a spring in a retracted state according to a further another embodiment;

FIG. 6 schematically illustrates a perspective side view of the pit buffer stand of FIG. 5 in an extended state;

FIG. 7 shows a flowchart of a method of using the pit buffer stand.

### DETAILED DESCRIPTION OF THE INVENTION

In the following, embodiments of the present disclosure are explained with reference to the drawings. The same elements are assigned the same reference numbers in the drawings. It is to be noted that the embodiments are described for exemplary purposes only and the description of the embodiments is not intended to limit the scope of the present disclosure.

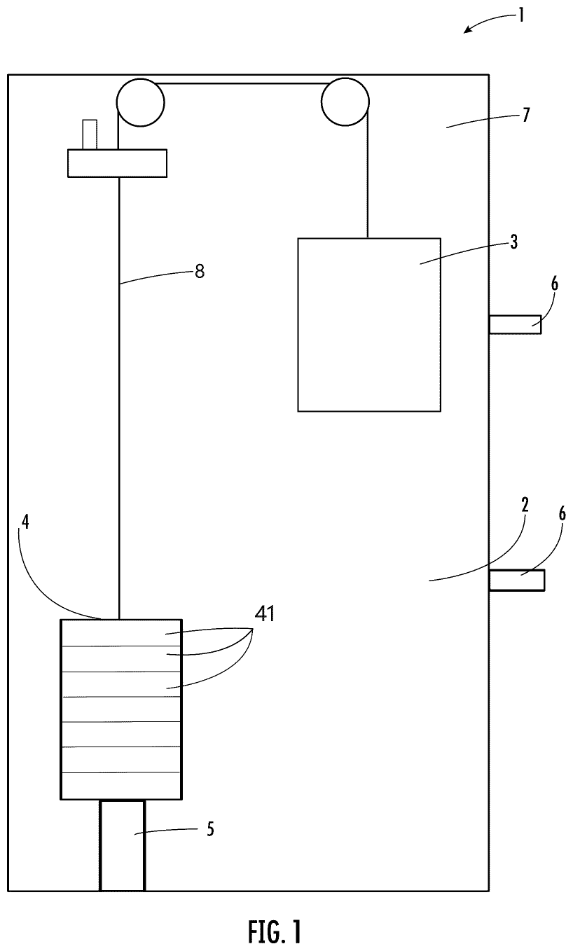

FIG. 1 shows the basic structure of an elevator system 1. The elevator system 1 comprises an elevator car 3, a counterweight 4, a tension member 8 and a pit buffer stand 5 fixed to the floor of a hoistway 2. The elevator car 3 and the counterweight 4 are linked each other via the tension member 8. The hoistway 2 extends in a longitudinal direction between a plurality of landings 6 located on different floors of a building. The elevator car 3 is moved up and down concurrently and in opposite direction to the counterweight 4 in the hoistway 2 so as to transport the passengers to the different landings 6.

When the elevator car 3 moves up, the counterweight 4 moves down. However, downwards movement of the counterweight 4 may be limited by the pit buffer stand 5. For maintenance of the elevator system 1, the area above the elevator car 3, i.e., a maintenance area 7 needs to be large enough for the maintenance person to perform maintenance in the maintenance area 7 safely even when the elevator car 3 is at its uppermost position. However, during normal operation of the elevator system 1, creating such a maintenance area 7 is detrimental, as it occupies valuable space in the hoistway 2. Thus, the pit buffer stand 5 is usually retracted so that more of the hoistway 2 can be utilized to move the elevator car 3. With the pit buffer stand 5 the height of the maintenance area 7 can be adjusted.

When the elevator system 1 is operated in a normal operation mode, the pit buffer stand 5 is adjusted to a position so as not to affect the normal operation of the elevator car 3, i.e., the area above the elevator car 3 (when at its uppermost position) is adjusted to be as small as possible, so that the space of hoistway 2 is fully utilized.

When the elevator system 1 is in a maintenance mode, i.e., not in the normal operation mode, the pit buffer stand 5 is adjusted to stop the counterweight 4 in a higher position than in the normal operation mode of the elevator system 1. Thus, the elevator car 3 is stopped between the landings 6 (i.e., the bottom end of the elevator car 3 is positioned between the landings 6) and could not run till its maximum height. As a result, when the elevator car is in its uppermost position, the maintenance area 7 above the elevator car 3 is larger than the area above the elevator car 3 in the normal operation mode.

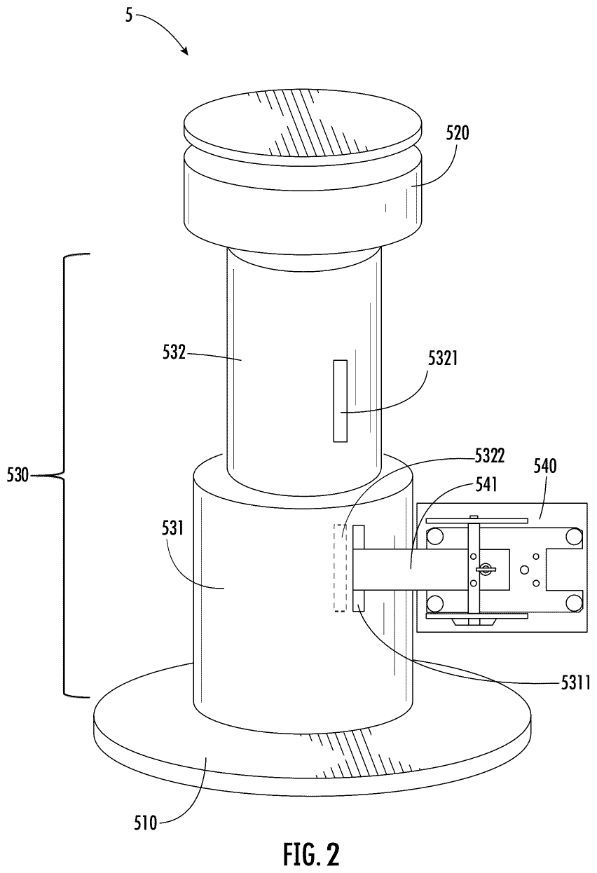

In the present disclosure, the pit buffer stand 5 is telescopic. In the maintenance mode of the elevator system 1, the pit buffer stand 5 is extended to its maximum length, i.e., to be in its extended state, as shown in FIG. 2, so as to stop the counterweight 4 in a higher position than in the normal operation mode of the elevator system 1.

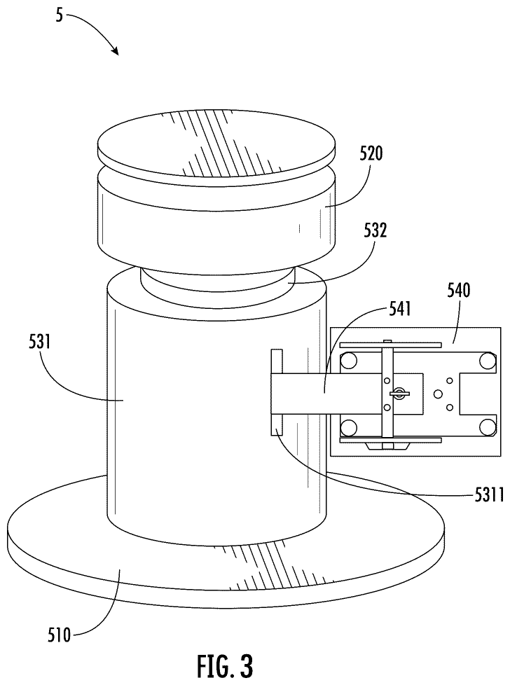

In the normal operation mode of the elevator system 1, the pit buffer stand 5 is retracted to its minimal length, i.e., to be in its retracted state, as shown in FIG. 3, so as to occupy a smaller space in the hoistway 2 than in its extended state. This allows the counterweight 4 to be moved only downwards till the upper end of the pit buffer stand 5 and not further.

The counterweight 4 may have a large number of stacked weight fillers 41 as shown in FIG. 1. The individual weight filler 41 may be plateshaped and may be made of a metal or concrete. All weight fillers 41 are similar or even identical in terms of their outer contour/dimensions. As a result, the weight fillers 41 can form a uniform composite when assembled, which composite can have a continuous outer contour along its length.

In elevator systems 1 known in the art, the pit buffer stand 5 occupies a comparatively large space in the hoistway 2. Therefore, in order to enable the counterweight 4 to be moved downwards beyond the upper end of the pit buffer stand 5 and thus utilize the lower space of the hoistway 2, the weight fillers 41 in the lower part of the counterweight 4 have to be manufactured to have a reduced width compared with the upper part of the counterweight 4. This way, it is possible to create a collision with the pit buffer stand 5, when the counterweight 4 is moved downwards beyond the upper end of the pit buffer stand 5.

In the present disclosure, because of the telescopic structure of the pit buffer stand 5, all weight fillers 41 of the counterweight 4 can have a uniform width from a top to a bottom of the counterweight 4. Therefore, the counterweight 4 can have a simple structure and, thus, be manufactured easily. In other words, the weight fillers in the lower part of the counterweight 4 are not necessary to be manufactured to have a reduced width compared with the upper part of the counterweight 4. Thus the present disclosure avoids the possible collisions between the lower end of the counterweight 4 with a reduced width and the pit buffer stand 5.

Optionally, the elevator system 1 may comprise two or more pit buffer stands 5, so as to support the counterweight 4 more strongly and stably in the maintenance mode. The layout of the two or more pit buffer stands 5 is not limited here, for example, they may be mounted on the floor of the hoistway 2 next to each other or at a distance to each other.

As shown in FIG. 2, the pit buffer stand 5 comprises a first portion 510, a second portion 520 and a telescopic bar 540 connecting the first portion 510 and the second portion 520 with each other.

The first portion 510 is to be fixed to the floor of the hoistway 2 so as to enable the pit buffer stand 5 to be mounted in the hoistway 2 stably and robustly.

The second portion 520 forms a support for the counterweight 4 in the maintenance mode of the elevator system 1.

As shown in FIGS. 2, 3, 5, and 6, the first part 531 and the second part 532 of the telescopic bar 530 each have cylindrical cross sections. Nevertheless, this is exemplary in nature only and not intended to be limiting. Other cross sections, e.g., square cross sections of first part 531 and second part 532, are possible as well.

In addition, the first portion 510 and the second portion 520 of the pit buffer stand 5 may have a bigger cross section than the telescopic bar 530. The first portion 510 may have a bigger cross section than the second portion 520. Furthermore, the first portion 510, the second portion 520 and the telescopic bar 530 may be made of the same material, for example, of a metal, like steel, or made of different materials. For example, the second portion 520 may be made at least partially of rubber, and the telescopic bar 530 and/or the first portion 510 may be made of steel.

The telescopic bar 530 is telescopic and arranged between the first portion 510 and the second portion 520.

The telescopic bar 530 may comprise a first part 531 being connected to the first portion 510 of the pit buffer stand 5 (as described above) and a second part 532 being connected to the second portion 520 of the pit buffer stand 5 (as described above). The first part 531 and the second part 532 may be at least partially inserted into each other. Alternatively, the first part 531 is formed integrally with the first portion 510 and the second part 532 is formed integrally with the second portion 520. Alternatively, the telescopic bar 530 can also comprise more than two parts.

When the first part 531 and the second part 532 are maximally inserted into each other, the telescopic bar 530/the pit buffer stand 5 is in its retracted state. When the second part 532 is pulled out of the first part 531, the telescopic bar 530/the pit buffer stand 5 is in its extended state.

In one exemplary embodiment, the first part 531 is fixed to the first portion 510 and hollow. The second part 532 has a smaller cross section than an inner cross section of the first part 531 and can be at least partially inserted into the first part 531. The second part 532 may also be hollow.

The length of the second part 532 may be equal to or greater than that of the first part 531, so that the telescopic bar 530 can be extended longer than in the condition that the length of the second part 532 is shorter than that of the first part 531. Nevertheless, the size of the first part 531 and the second part 532 of the telescopic bar can be determined as required.

In addition, the first part 531 of the telescopic bar 530 may have an outer contour that is adapted to the inner contour of the first portion 510, and the second part 532 of the telescopic bar 530 may have an outer contour that is adapted such to the inner contour of the second portion 520, that it is formfit. This has the advantage, that this improves rigidity/prevents tilting by easy means.

The pit buffer stand 5 may further comprise a blocking device 540 that can be operated to change between a blocking position and an unblocking position. In the blocking position, the first portion 510 and the second portion 520 are fixed in position relative to each other. In the unblocking position, the first portion 520 and the second portion 520 are movable relative to each other.

The blocking device 540 may comprise at least one blocking rod 541. The change of the blocking rod 541 between its blocking position and its unblocking position can be realized manually, for example, by the maintenance staff, or operated by a mechanical and/or electromechanical controller which is connected with the blocking rod 541.

FIG. 2 shows an example of the blocking device 540 with a mechanical structure. As shown in FIG. 2, the blocking device 540 may comprise, besides the blocking rod 541, further elements, like plates, bars or levers and/or a switch.

In one example, at least one first opening 5311 may be provided in the first part 531 and at least one second opening 5321 may be provided in the second part 532. Here, the at least one first opening 5311 and the at least one second opening 5321 are preferably designed equally. For example, as shown in FIG. 2, the first opening 5311 and the second opening 5321 are elongated openings, and the blocking rod 541 is a strip with a certain thickness, which can pass through these elongated openings. Nevertheless, there is no restriction to the shape of the first opening 5311, the second opening 5321 and the blocking rod 541.

In the embodiment only one first opening 5311, only one second opening 5321 and only one blocking device 540 are provided. When the blocking device 540 is in the blocking position, the first opening 5311 and the second opening 5321 are laterally aligned with each other, and the blocking rod 541 is inserted into both the first opening 5311 and the second opening 5321, as shown in FIG. 3. In this case, the first part 531 and the second part 532 are not movable relative to each other, and, as a result, the telescopic bar 530 and the pit buffer stand 5 are kept in the retracted state.

When the blocking device 540 is in the unblocking position, the blocking rod 541 is pulled out of the first and second openings 5311, 5321 and the second part 532 is pulled out of the first part 531, and the second opening 5321 can be accordingly moved upwards and away from the first opening 5311, as shown in FIG. 2. The blocking rod 541 can then be inserted again to support the bottom end of the second part 532 to prevent the second part 532 from moving downwards (e.g., by force of gravity). In this way, the telescopic bar 530 and the pit buffer stand 5 are kept in the extended state stably.

In another embodiment another second opening 5322 may be provided in the lower portion of the second part 532, vertically below the second opening 5321. In the extended state of the telescopic bar 530, the another second opening 5322 is laterally aligned with the first opening 5311 and the blocking rod 541 can be inserted into the first opening 5311 and the another second opening 5322 to avoid the second part 532 to go downwards. In this way, the second part 532 can again be fixed relative to the first part 531.

In another exemplary embodiment, the second part 532 can be hollow and can have a bigger cross section than the first part 531 and the first part 531 can be at least partially inserted inside the second part 532. In the blocking position of the blocking device 540, the first part 531 and the second part 532 are fixed to each other in a similar way as described above. In the unblocking position of the blocking device 540, the blocking rod 541 can be moved upwards together with the second part 532 and be supported by the top end of the first part 531 so as to prevent the second part 532 from moving downwards (e.g., by force of gravity).

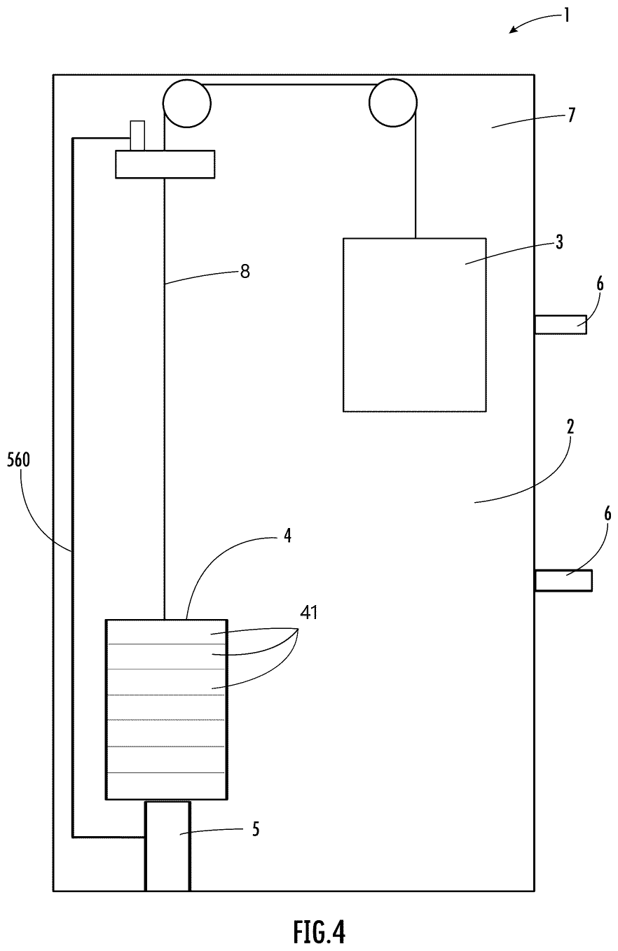

The pit buffer stand 5 may further comprise a traction device 560. The traction device 560 can be used to move the telescopic bar 530 between its extended state and its retracted state. For example, the traction device 560 may comprise at least one rope arranged between the maintenance area 7 and the telescopic bar 530, as indicated in FIG. 4.

Alternatively, the traction device 560 may be coupled with the blocking device 540 to operate the blocking device 540 between its blocking position and its unblocking position. For example, the traction device 560 may be used to pull the blocking rod 541 out of the second portion 532 and/or out of the first portion 531 and avoid the second part 532 to go downwards in the extended state of the telescopic bar 530.

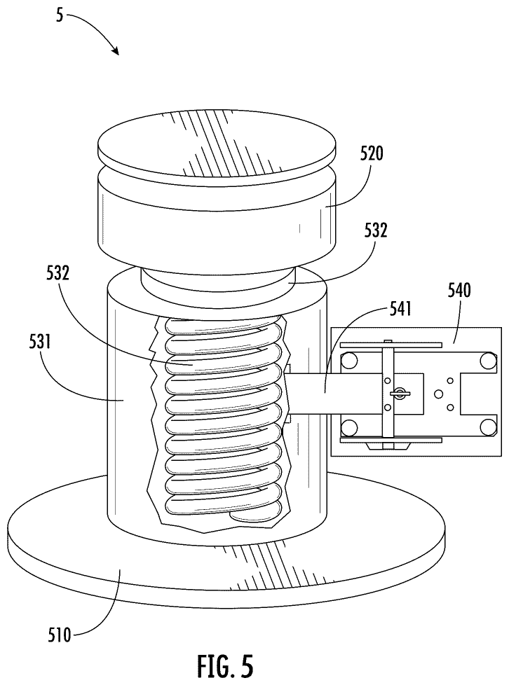

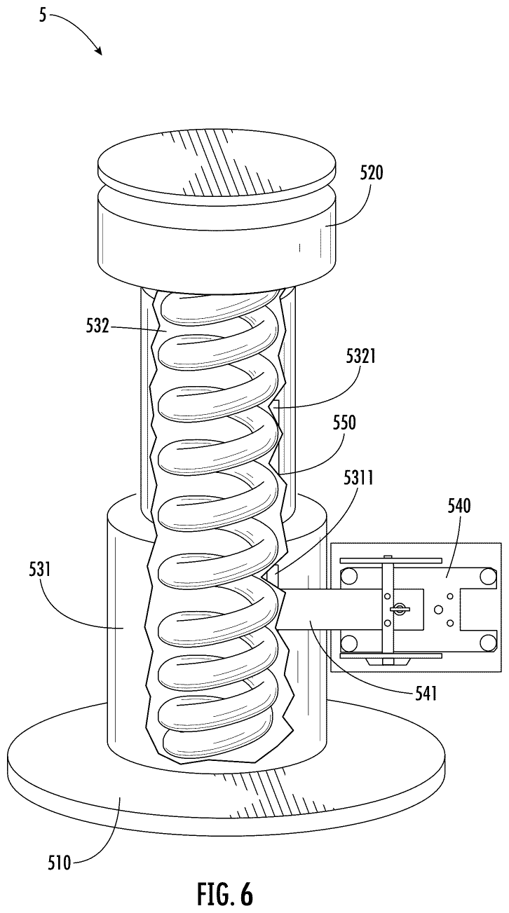

The telescopic bar 530 may further comprise an elastic member 550, such as a spring, as shown in FIGS. 5 and 6. The elastic member 550 can be a coil spring. The elastic member 550 can be arranged along a central axis of the telescopic bar 530. The two ends of the elastic member 550 contact the upper end of the first portion 531 and the lower end of the second portion 532 respectively. In this embodiment, both the first portion 531 and the second portion 532 should be hollow so as to accommodate the elastic member 550. In the retracted state of the telescopic bar 530, the elastic member 550 is compressed between the first portion 510 and the second portion 520, as shown in FIG. 5. In the extended state of the telescopic bar 530, the elastic member 550 may be partially compressed or uncompressed to push against the second part 532 to be in its maximal extended position.

When the telescopic bar 530 includes the elastic member 550, in the previously described embodiments, the blocking rod 541 may be inserted in both, the first opening 5311 and the another second opening 5321 in the extended state of the telescopic bar 530.

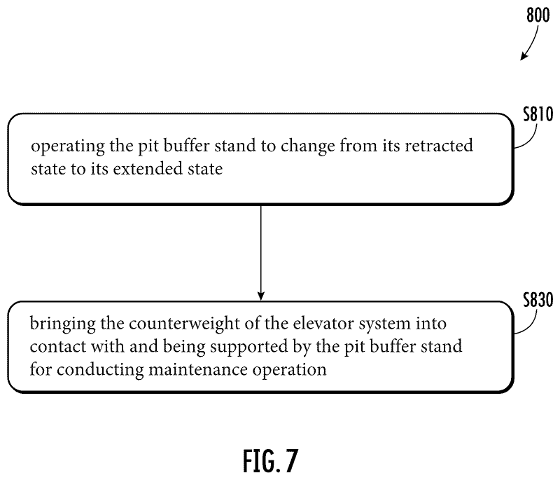

As shown in FIG. 7, a method 800 of using a pit buffer stand for maintaining an elevator system is provided. The method 800 of using a pit buffer stand for maintaining an elevator system comprises:
S810: operating the pit buffer stand 5 to change from its retracted state to its extended state, and
S830: bringing the counterweight 4 of the elevator system 1 into contact with and being supported by the pit buffer stand 5 for conducting maintenance operation.

What is claimed is:

1. Pit buffer stand (5) for an elevator system (1) comprising
a first portion (510) for being fixed to a floor of a hoistway (2) and
a second portion (520) that forms a support for a counterweight (4) of the elevator system (1) in a maintenance mode of the elevator system (1),
wherein the pit buffer stand (5) further comprises a telescopic bar (530), wherein the telescopic bar (530) connects the first portion (510) and the second portion (520) with each other.

2. The pit buffer stand (5) according to claim 1, wherein the telescopic bar (530) comprises a first part (531) being connected to the first portion (510) and a second part (532) being connected to the second portion (520), wherein the first part (531) and the second part (532) are at least partially inserted into each other.

3. The pit buffer stand (5) according to claim 2, wherein the first part (531) is hollow and the second part (532) is inserted into the first part (531).

4. The pit buffer stand (5) according to claim 1, wherein the pit buffer stand (5) further comprises a traction device (560), the traction device (560) being configured to move the telescopic bar (530) between an extended state and a retracted state.

5. The pit buffer stand (5) according to claim 4, wherein the traction device (560) is a rope configured for being arranged between a maintenance area (7) of the elevator system (1) and the telescopic bar (530).

6. The pit buffer stand (5) according to claim 1, wherein the pit buffer stand (5) further comprises a blocking device (540), the blocking device (540) being movable between a blocking position, in which the first portion (510) and the second portion (520) are fixed in position relative to each other, and an unblocking position, in which the first portion (520) and the second portion (520) are movable relative to each other.

7. The pit buffer stand (5) according to claim 6, wherein a first opening (5311) is provided in the first part (531), at least one second opening (5321) is provided in the second part (532), and the blocking device (540) comprises a blocking rod (541), wherein the blocking rod (541) can be inserted into the first opening (5311) and the at least one second opening (5321).

8. The pit buffer stand (5) according to claim 7, wherein in the retracted state of the telescopic bar (530) the first opening (5311) and the at least one second opening (5321) are aligned with each other and the blocking rod (541) is inserted into both the first opening (5311) and the at least one second opening (5321) to block the first part (531) relative to the second part (532).

9. The pit buffer stand (5) according to claim 7, wherein in the extended state the blocking rod (541) penetrates the first opening (5311) and penetrates another second opening (5321) or penetrates the first opening (5311) and supports a bottom end of the second part (532).

10. The pit buffer stand (5) according to claim 4, wherein the traction device (560) is coupled with the blocking device (540) to move it between its blocking position and its unblocking position.

11. The pit buffer stand (5) according to claim 1, wherein the telescopic bar (530) includes an elastic member (550) being arranged along a central axis of the telescopic bar (530), wherein the elastic member (550) is compressed in the retracted state of the telescopic bar (530).

12. The pit buffer stand (5) according to claim 1, wherein the first part (531) and the second part (532) each have cylindrical cross sections.

13. Elevator system (1) comprising a counterweight (4) and a pit buffer stand (5) according to claim 1.

14. Elevator system according to claim 13, wherein all weight fillers of the counterweight (4) have a uniform width from a top to a bottom of the counterweight (4).

15. Method of using a pit buffer stand (5) according to claim 1 for maintaining an elevator system (1) comprising the steps:
a) operating the pit buffer stand (5) to change from its retracted state to its extended state, and
b) bringing a counterweight (4) of the elevator system (1) into contact with and being supported by the pit buffer stand (5) for conducting maintenance operation.
